(19) United States
(12) Patent Application Publication
(10) Pub. No.: US 2026/0184917 A1
(43) Pub. Date: Jul. 2, 2026

(54) CHEMICALLY RESISTANT POLYCARBONATE COMPOSITIONS AND ARTICLES MADE THEREFROM

(71) Applicant: SHPP GLOBAL TECHNOLOGIES B.V., Bergen op Zoom (NL)

(72) Inventors: Peter Vollenberg, Evansville, IN (US); Yuntao Li, Newburgh, IN (US)

(21) Appl. No.: 19/129,913

(22) PCT Filed: Oct. 25, 2023
(86) PCT No.: PCT/IB2023/060762

§ 371 Date: May 14, 2025

(30) Foreign Application Priority Data
Nov. 16, 2022 (EP) 22207871.9

(51) Int. Cl. C08L 69/00; C08J 3/20; C08K 5/524

(52) U.S. Cl. CPC C08L 69/00; C08J 3/203; C08K 5/524; C08J 2369/00; C08J 2469/00; C08L 2203/20; C08L 2205/025; C08L 2205/035

(57) ABSTRACT

A polycarbonate composition includes particular amounts of a linear polycarbonate, a first poly(carbonate-siloxane) copolymer, a second poly(carbonate-siloxane) copolymer and optionally, one or more of a branched polycarbonate, a highly branched polycarbonate, or a second linear polycarbonate. Methods for the manufacture of the composition are also disclosed. The compositions can be particularly useful in the preparation of various articles, particularly thin-walled articles for application where a high degree of chemical resistance is desired.

### CROSS REFERENCE TO RELATED APPLICATION

This application claims priority to European Patent Application No. 22207871.9, filed on Nov. 16, 2022, the contents of which are hereby incorporated by reference in their entirety.

### BACKGROUND

This disclosure relates to polycarbonate compositions, and in particular to transparent, chemically resistant polycarbonate compositions, methods of manufacture, and uses thereof.

Polycarbonates are useful in the manufacture of articles and components for a wide range of applications, from automotive parts to electronic appliances. Because of their broad use, it is desirable to provide polycarbonates that when molded into transparent articles having thin walls are chemically resistant.

There accordingly remains a need in the art for polycarbonate compositions that are chemically resistant and provide transparency.

### SUMMARY

A polycarbonate composition comprises: 35 to 94 weight percent of a linear polycarbonate; 5 to 20 weight percent of a first poly(carbonate-siloxane) copolymer having a siloxane content of 4 to 15 weight percent, based on the total weight of the first poly(carbonate-siloxane) copolymer; and 1 to 6 weight percent of a second poly(carbonate-siloxane) copolymer having a siloxane content of 35 to 60 weight percent, based on the total weight of the second poly(carbonate-siloxane) copolymer; wherein weight percent of each component is based on the total weight of the composition; wherein the polycarbonate composition has a total siloxane content of less than 2.5 weight percent, based on the total weight of the composition; and wherein the composition comprises less than 1 weight percent of a flame retardant having a phosphorus-nitrogen bond.

A method of making the polycarbonate composition comprises melt-mixing the components of the composition.

An article comprising the polycarbonate composition represents another aspect of the disclosure.

The above described and other features are exemplified by the following detailed description.

### DETAILED DESCRIPTION

Due to the miniaturization of electronic parts and market trends, there is a need for transparent, chemically resistant articles with good processability (i.e., ductility). Branched polycarbonates can be incorporated to impart desirable properties, but molded articles prepared from branched polycarbonates can be brittle and lack ductility. Poly(carbonate-siloxane) copolymers can be added to improve the impact resistance of branched thermoplastic compositions, but it can be challenging to determine the combination of poly(carbonate-siloxane) copolymers that improve the ductility of the compositions, without sacrificing transparency. Achieving good chemical resistance can add a further challenge to providing a composition which can exhibit a good balance of the aforementioned properties.

The present inventors have unexpectedly discovered that a composition including particular amounts of a linear polycarbonate, a first poly(carbonate-siloxane) copolymer having a siloxane content of 4 to 15 weight percent, a second poly(carbonate-siloxane) copolymer having a siloxane content of 35 to 60 weight percent, and optionally one or more of a branched polycarbonate, a highly branched polycarbonate, or a second linear polycarbonate can provide a desirable combination of chemical resistance, transparency, and mechanical properties.

Accordingly, a polycarbonate composition represents an aspect of the present disclosure. The polycarbonate composition comprises a linear polycarbonate. “Polycarbonate” as used herein means a polymer having repeating structural carbonate units of formula (I)

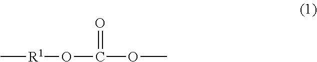

in which at least 60 percent of the total number of R¹ groups contain aromatic moieties and the balance thereof are aliphatic, alicyclic, or aromatic. In an aspect, each R¹ is a C₆₋₃₀ aromatic group, that is, contains at least one aromatic moiety. R¹ can be derived from an aromatic dihydroxy compound of the formula HO—R¹—OH, in particular of formula (2)

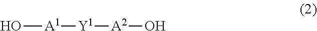

wherein each of A¹ and A² is a monocyclic divalent aromatic group and Y¹ is a single bond or a bridging group having one or more atoms that separate A¹ from A². In an aspect, one atom separates A¹ from A². Preferably, each R¹ can be derived from a bisphenol of formula (3)

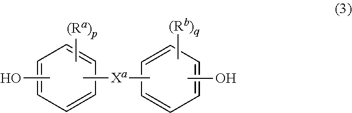

wherein R^{a} and R^{b} are each independently a halogen, C₁₋₁₂ alkoxy, or C₁₋₁₂ alkyl, and p and q are each independently integers of 0 to 4. It will be understood that when p or q is less than 4, the valence of each carbon of the ring is filled by hydrogen. Also in formula (3), X^{a} is a bridging group connecting the two hydroxy-substituted aromatic groups, where the bridging group and the hydroxy substituent of each C₆ arylene group are disposed ortho, meta, or para (preferably para) to each other on the C₆ arylene group. In an aspect, the bridging group X^{a} is single bond, —O—, —S—, —S(O)—, —S(O)₂—, —C(O)—, or a C₁₋₆₀ organic group. The organic bridging group can be cyclic or acyclic, aromatic or non-aromatic, and can further comprise heteroatoms such as halogens, oxygen, nitrogen, sulfur, silicon, or phosphorous. The C₁₋₆₀ organic group can be disposed such that the C₆ arylene groups connected thereto are each connected to a common alkylidene carbon or to different carbons of the C₁₋₆₀ organic bridging group. In an aspect, p and q is each 1, and R^{a} and R^{b} are each a C₁₋₃ alkyl group, preferably methyl, disposed meta to the hydroxy group on each arylene group.

In an aspect, X^{a} is a C₃₋₁₈ cycloalkylidene, a C₁₋₂₅ alkylidene of formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. Groups of these types include methylene, cyclohexylmethylidene, ethylidene, neopentylidene, and isopropylidene, as well as 2-[2.2.1]-bicycloheptylidene, cyclohexylidene, 3,3-dimethyl-5-methylcyclohexylidene, cyclopentylidene, cyclododecylidene, and adamantylidene.

In another aspect, X^{a} is a C₁₋₁₈ alkylene, a C₃₋₁₈ cycloalkylene, a fused C₆₋₁₈ cycloalkylene, or a group of the formula -J¹-G-J²- wherein JP and J² are the same or different C₁₋₆ alkylene and G is a C₃₋₁₂ cycloalkylidene or a C₆₋₁₆ arylene.

For example, X^{a} can be a substituted C₃₋₁₈ cycloalkylidene of formula (4)

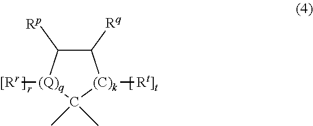

wherein R^{r}, R^{p}, R^{q}, and R^{t} are each independently hydrogen, halogen, oxygen, or C₁₋₁₂ hydrocarbon groups; Q is a direct bond, a carbon, or a divalent oxygen, sulfur, or —N(Z)— where Z is hydrogen, halogen, hydroxy, C₁₋₁₂ alkyl, C₁₋₁₂ alkoxy, C₆₋₁₂ aryl, or C₁₋₁₂ acyl; r is 0 to 2, t is 1 or 2, q is 0 or 1, and k is 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (4) will have an unsaturated carbon-carbon linkage where the ring is fused. When k is one and q is 0, the ring as shown in formula (4) contains 4 carbon atoms, when k is 2, the ring as shown in formula (4) contains 5 carbon atoms, and when k is 3, the ring contains 6 carbon atoms. In an aspect, two adjacent groups (e.g., R^{q} and R^{t} taken together) form an aromatic group, and in another aspect, R^{q} and R^{t} taken together form one aromatic group and R^{r} and R^{p} taken together form a second aromatic group. When R^{q} and R^{t} taken together form an aromatic group, R^{p} can be a double-bonded oxygen atom, i.e., a ketone, or Q can be —N(Z)— wherein Z is phenyl.

Bisphenols wherein X^{a} is a cycloalkylidene of formula (4) can be used in the manufacture of polycarbonates containing phthalimidine carbonate units of formula (5a)

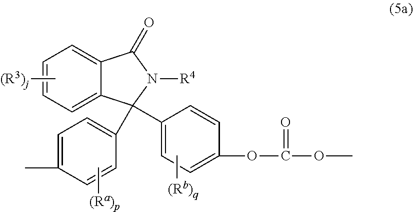

wherein R^{a}, R^{b}, p, and q are as in formula (3), R³ is each independently a C₁₋₆ alkyl, j is 0 to 4, and R₄ is hydrogen, C₁₋₆ alkyl, or a substituted or unsubstituted phenyl, for example a phenyl substituted with up to five C₁₋₆ alkyls. For example, the phthalimidine carbonate units are of formula (5b)

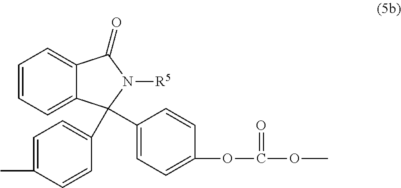

wherein R⁵ is hydrogen, phenyl optionally substituted with up to five 5 C₁₋₆ alkyls, or C₁₋₄ alkyl. In an aspect in formula (5b), R⁵ is hydrogen, methyl, or phenyl, preferably phenyl. Carbonate units (5b) wherein R⁵ is phenyl can be derived from 2-phenyl-3,3′-bis(4-hydroxy phenyl)phthalimidine (also known as 3,3-bis(4-hydroxyphenyl)-2-phenylisoindolin-1-one, or N-phenyl phenolphthalein bisphenol (“PPPBP”)).

Other bisphenol carbonate repeating units of this type are the isatin carbonate units of formula (5c) and (5d)

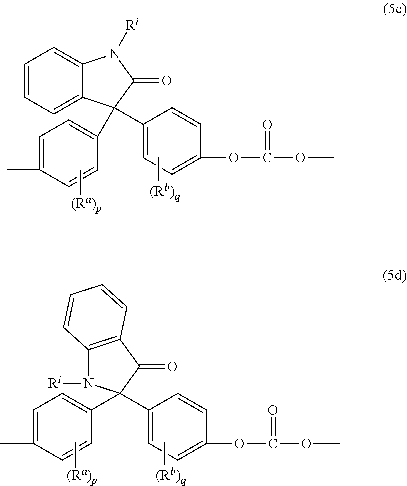

wherein R^{a} and R^{b} are each independently a halogen, C₁₋₁₂ alkoxy, or C₁₋₁₂ alkyl, p and q are each independently 0 to 4, and Rⁱ is C₁₋₁₂ alkyl, phenyl optionally substituted with 1 to 5 C₁₋₁₀ alkyl, or benzyl optionally substituted with 1 to 5 C₁₋₁₀ alkyl. In an aspect, R^{a} and R^{b} are each methyl, p and q are each independently 0 or 1, and Rⁱ is C₁₋₄ alkyl or phenyl.

Other examples of bisphenol carbonate units derived from bisphenols (3) wherein X^{a} is a substituted or unsubstituted C₃₋₁₈ cycloalkylidene include the cyclohexylidene-bridged bisphenol of formula (5e)

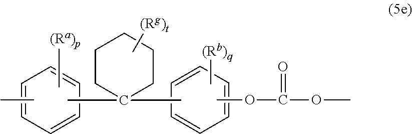

wherein R^{a} and R^{b} are each independently C₁₋₁₂ alkyl, R^{g} is C₁₋₁₂ alkyl, p and q are each independently 0 to 4, and t is 0 to 10. In a specific aspect, at least one of each of R^{a} and R^{b} are disposed meta to the cyclohexylidene bridging group. In an aspect, R^{a} and R^{b} are each independently C₁₋₄ alkyl, R^{g} is C₁₋₄ alkyl, p and q are each 0 or 1, and t is 0 to 5. In another specific aspect, R^{a}, R^{b}, and R^{g} are each methyl, p and q are each 0 or 1, and t is 0 or 3, preferably 0. In still another aspect, p and q are each 0, each R^{g} is methyl, and t is 3, such that X^{a} is 3,3-dimethyl-5-methyl cyclohexylidene.

Examples of other bisphenol carbonate units derived from bisphenol (3) wherein X^{a} is a substituted or unsubstituted C₃₋₁₈ cycloalkylidene include adamantyl units of formula (5f) and fluorenyl units of formula (5g)

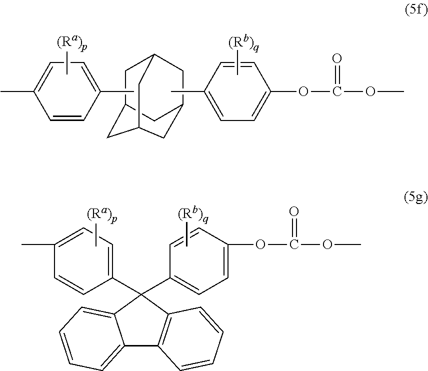

wherein R^{a} and R^{b} are each independently C₁₋₁₂ alkyl, and p and q are each independently 1 to 4. In a specific aspect, at least one of each of R^{a} and R^{b} are disposed meta to the cycloalkylidene bridging group. In an aspect, R^{a} and R^{b} are each independently C₁₋₃ alkyl, and p and q are each 0 or 1; preferably, R^{a}, R^{b} are each methyl, p and q are each 0 or 1, and when p and q are 1, the methyl group is disposed meta to the cycloalkylidene bridging group. Carbonates containing units (1a) to (1g) are useful for making polycarbonates with high glass transition temperatures (Tg) and high heat distortion temperatures.

Other useful dihydroxy compounds of the formula HO—R¹—OH include aromatic dihydroxy compounds of formula (6)

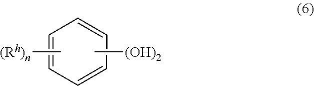

wherein each is independently a halogen atom, C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4. The halogen is usually bromine.

Some illustrative examples of specific dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or a combination thereof.

Specific examples of bisphenol compounds of formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). A combination can also be used. In a specific aspect, the polycarbonate is a linear homopolymer derived from bisphenol A, in which each of A¹ and A² is p-phenylene and Y¹ is isopropylidene in formula (3).

The linear polycarbonate can include a bisphenol A polycarbonate homopolymer, also referred to as a bisphenol A homopolycarbonate. The bisphenol A polycarbonate homopolymer has repeating structural carbonate units of the formula (7).

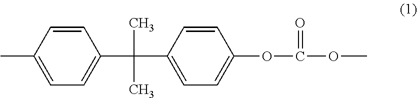

Polycarbonates can be manufactured by processes such as interfacial polymerization and melt polymerization, which are known, and are described, for example, in WO 2013/175448 A1 and WO 2014/072923 A1. An end-capping agent (also referred to as a chain stopper agent or chain terminating agent) can be included during polymerization to provide end groups, for example monocyclic phenols such as phenol, p-cyanophenol, and C₁₋₂₂ alkyl-substituted phenols such as p-cumyl-phenol, resorcinol monobenzoate, and p- and tertiary-butyl phenol, monoethers of diphenols, such as p-methoxyphenol, monoesters of diphenols such as resorcinol monobenzoate, functionalized chlorides of aliphatic monocarboxylic acids such as acryloyl chloride and methacryoyl chloride, and mono-chloroformates such as phenyl chloroformate, alkyl-substituted phenyl chloroformates, p-cumyl phenyl chloroformate, and toluene chloroformate. Combinations of different end groups can be used.

The polycarbonates can have an intrinsic viscosity, as determined in chloroform at 25° C., of 0.3 to 1.5 deciliters per gram (dl/gm), preferably 0.45 to 1.0 dl/gm. The polycarbonates can have a weight average molecular weight (Mw) of 10,000 to 200,000 grams per mole (g/mole), preferably 20,000 to 100,000 g/mole, as measured by gel permeation chromatography (GPC), using a crosslinked styrene-divinylbenzene column according to polycarbonate standards. GPC samples are prepared at a concentration of 1 mg per ml, and are eluted at a flow rate of 1.5 ml per minute.

In an aspect, the linear polycarbonate can have a weight average molecular weight of 15,000 to less than 34,000 grams per mole, or 25,000 to 33,000 grams per mole, or 30.000 to 33,000 grams per mole, as measured by gel permeation chromatography (GPC), using a crosslinked styrene-divinylbenzene column according to polycarbonate standards. In an aspect, the linear polycarbonate can be a linear bisphenol A homopolycarbonate having a weight average molecular weight of 15,000 to less than 34,000 grams per mole, or 25,000 to 33,000 grams per mole, or 30,000 to 33,000 grams per mole, as measured by gel permeation chromatography (GPC), using a crosslinked styrene-divinylbenzene column according to polycarbonate standards.

The linear polycarbonate can be present in the composition in an amount of 35 to 94 weight percent, based on the total weight of the polycarbonate composition. Within this range, the linear polycarbonate can be present in an amount of at least 38 weight percent, or at least 40 weight percent, or at least 45 weight percent, or at least 50 weight percent, or at least 60 weight percent, or at least 70 weight percent, or at least 75 weight percent, or at least 79 weight percent, each based on the total weight of the polycarbonate composition. Also within this range, the linear polycarbonate can be present in an amount of at most 90 weight percent, or at most 89 weight percent, or at most 74 weight percent, or at most 65 weight percent, or at most 54 weight percent, each based on the total weight of the polycarbonate composition. For example, in an aspect, the linear polycarbonate can be present in the composition in an amount of 79 to 89 weight percent. In an aspect, the linear polycarbonate can be present in the composition in an amount of 40 to 74 weight percent. In an aspect, the linear polycarbonate can be present in the composition in an amount of 40 to 54 weight percent.

The polycarbonate composition further includes a combination of poly(carbonate-siloxane) copolymers. A poly(carbonate-siloxane) copolymer comprises carbonate repeating units as defined above and polysiloxane blocks. The polysiloxane blocks of the poly(carbonate-siloxane)s comprise repeating diorganosiloxane units as in formula (8)

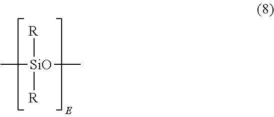

wherein each R is independently a C₁₋₁₃ monovalent organic group. For example, R can be a C₁₋₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkylene, C₇₋₁₃ arylalkylenoxy, C₇₋₁₃ alkylarylene, or C₇₋₁₃ alkylaryleneoxy. The foregoing groups can be fully or partially halogenated with fluorine, chlorine, bromine, or iodine, or a combination thereof. In an aspect, where a transparent poly(carbonate-siloxane) is desired, R is unsubstituted by halogen. Combinations of the foregoing R groups can be used in the same copolymer.

The value of E in formula (8) can vary widely depending on the type and relative amount of each component in the thermoplastic composition, the desired properties of the composition, and like considerations. Generally, E has an average value of 2 to 1,000, preferably 2 to 500, 2 to 200, or 2 to 125, 5 to 80, or 10 to 70. In an aspect, E has an average value of 10 to 80 or 10 to 40, and in still another aspect, E has an average value of 40 to 80, or 40 to 70. Where E is of a lower value, e.g., less than 40, it can be desirable to use a relatively larger amount of the poly(carbonate-siloxane) copolymer. Conversely, where E is of a higher value, e.g., greater than 40, a relatively lower amount of the poly(carbonate-siloxane) copolymer can be used. A combination of a first and a second (or more) poly(carbonate-siloxane) copolymers can be used, wherein the average value of E of the first copolymer is less than the average value of E of the second copolymer.

In an aspect, the polsiloxane blocks are of formula (9)

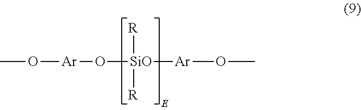

wherein E and R are as defined if formula (8); each R can be the same or different, and is as defined above; and Ar can be the same or different, and is a substituted or unsubstituted C₆₋₃₀ arylene, wherein the bonds are directly connected to an aromatic moiety. Ar groups in formula (9) can be derived from a C₆₋₃₀ dihydroxyarylene compound, for example a dihydroxyarylene compound of formula (3) or (6). Dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane.

In another aspect, polysiloxane blocks are of formula (10)

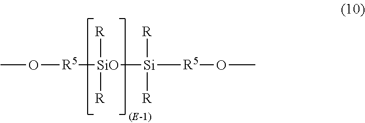

wherein R and E are as described above, and each R⁵ is independently a divalent C₁₋₃₀ organic group, and wherein the polymerized polysiloxane unit is the reaction residue of its corresponding dihydroxy compound. In a specific aspect, the polysiloxane blocks are of formula (11):

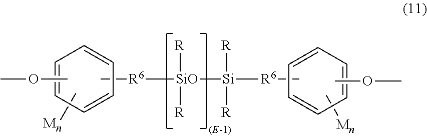

wherein R and E are as defined above. R⁶ in formula (11) is a divalent C₂₋₈ aliphatic group. Each M in formula (14) can be the same or different, and can be a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ aralkyl, C₇₋₁₂ aralkoxy, C₇₋₁₂ alkylaryl, or C₇₋₁₂ alkylaryloxy, wherein each n is independently 0, 1, 2, 3, or 4.

In an aspect. M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R is a C₁₋₈ alkyl, haloalkyl such as trifluoropropyl, cyanoalkyl, or aryl such as phenyl, chlorophenyl or tolyl. In another aspect, R is methyl, or a combination of methyl and trifluoropropyl, or a combination of methyl and phenyl. In still another aspect, R is methyl, M is methoxy, n is one, and R⁶ is a divalent C₁₋₃ aliphatic group. Specific polysiloxane blocks are of the formula

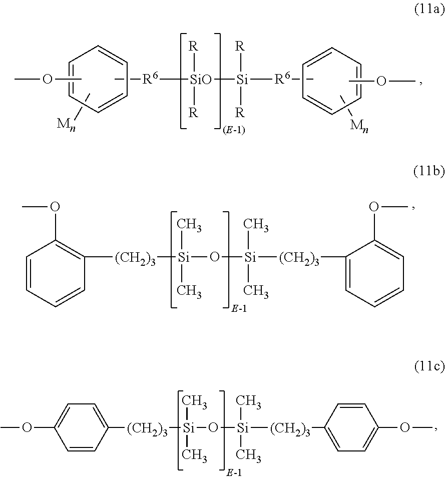

or a combination thereof, wherein E has an average value of 2 to 200, 2 to 125, 5 to 125, 5 to 100, 5 to 50, 20 to 80, or 5 to 20.

Blocks of formula (11) can be derived from the corresponding dihydroxy polysiloxane, which in turn can be prepared effecting a platinum-catalyzed addition between the siloxane hydride and an aliphatically unsaturated monohydric phenol such as eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. The poly(carbonate-siloxane) copolymers can then be manufactured, for example, by the synthetic procedure of European Patent Application Publication No. 0 524 731 A1 of Hoover, page 5, Preparation 2.

Transparent poly(carbonate-siloxane) copolymers comprise carbonate units (1) derived from bisphenol A, and repeating siloxane units (11a), (11b), (11c), or a combination thereof (preferably of formula 11a), wherein E has an average value of 4 to 50, 4 to 15, preferably 5 to 15, more preferably 6 to 15, and still more preferably 7 to 10. The transparent copolymers can be manufactured using one or both of the tube reactor processes described in U.S. Patent Application No. 2004/0039145A1 or the process described in U.S. Pat. No. 6,723,864 can be used to synthesize the poly(carbonate-siloxane) copolymers.

A combination of a first and a second poly(carbonate-siloxane) copolymer are included in the thermoplastic compositions. The first poly(carbonate-siloxane) has a siloxane content of 4 to 15 wt %, based on the total weight of the first poly(carbonate-siloxane). Within this range, the first poly(carbonate-siloxane) copolymer can have a siloxane content of 4 to 10 wt %. As used herein, “siloxane content” of a poly(carbonate-siloxane) refers to the content of siloxane units based on the total weight of the poly(carbonate-siloxane). The second poly(carbonate-siloxane) has a siloxane content of 35 to 60 wt %, based on the total weight of the second poly(carbonate-siloxane). Within this range, the second poly(carbonate-siloxane) can have a siloxane content of 35-55 wt %, or 35-45 wt %.

The first poly(carbonate-siloxane) can have a weight average molecular weight of 17,000 to 25,000 g/mole, preferably 19.000 to 25.000 g/mole as measured by GPC using a crosslinked styrene-divinyl benzene column, at a sample concentration of 1 milligram per milliliter, according to polycarbonate standards.

The second poly(carbonate-siloxane)s can have a weight average molecular weight of 2,000 to 100,000 grams per mole (g/mole), preferably 5,000 to 50,000 g/mole as measured by GPC using a crosslinked styrene-divinyl benzene column, at a sample concentration of 1 milligram per milliliter, measured according to polycarbonate standards. In an aspect, the second poly(carbonate-siloxane) can have a weight average molecular weight of at least 25,000 g/mole, preferably 27,000 g/mole. Within this range, the second poly(carbonate-siloxane) can have a weight average molecular weight of 25,000 to 100,000 g/mole, or 25,000 to 50,000 g/mole, or 30,000 to 40,000 g/mole.

The poly(carbonate-siloxane)s can have a melt volume flow rate, measured at 300° C./1.2 kg, of 1 to 50 cubic centimeters per 10 minutes (cc/10 min), preferably 2 to 30 cc/10 min. Combinations of the poly(carbonate-siloxane)s of different flow properties can be used to achieve the overall desired flow property.

The combination of poly(carbonate-siloxane)s can be present in the composition in an amount to provide a total siloxane content of less than 2.5 wt %, or less than 2.2 wt %, or less than 2 wt %, or less than 1.9 wt %, or less than 1.8 wt %, or less than 1.75 wt %, each based on the total weight of the polycarbonate composition.

In an aspect, a ratio of the siloxane content provided to the composition by the first poly(carbonate-siloxane) copolymer to the siloxane content provided to the composition by the second poly(carbonate-siloxane) copolymer can be 0.9:1 to 1:0.9, or 0.95:1 to 1:0.95, or 0.95:1 to 1:1.

The first poly(carbonate-siloxane) copolymer can be present in the composition in an amount of 5 to 20 weight percent, based on the total weight of the composition. Within this range, the first poly(carbonate-siloxane) copolymer can be present in an amount of 8 to 16 weight percent, or 10 to 16 weight percent, or 11 to 14 weight percent, each based on the total weight of the composition.

The second poly(carbonate-siloxane) copolymer can be present in the composition in an amount of 1 to 6 weight percent, based on the total weight of the composition. Within this range, the second poly(carbonate-siloxane) copolymer can be present in an amount of 1 to 5 weight percent, or 1 to 4 weight percent, or 1 to 3 weight percent, each based on the total weight of the composition.

The polycarbonate composition can optionally further comprise a branched polycarbonate or a highly branched polycarbonate or both. As used herein, the term “highly branched polycarbonate” refers to a polycarbonate having 1.5 to 5.0 mole % branching. The term “branched polycarbonate” refers to a polycarbonate having 0.1 to 1.0 mole % branching.

Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. Combinations comprising linear polycarbonates and branched polycarbonates can be used.

In an aspect, a particular type of branching agent can be used to create branched polycarbonate materials. These branched polycarbonate materials have statistically more than two end groups. The branching agent can be added in an amount (relative to the bisphenol monomer) that is sufficient to achieve the desired branching content, that is, more than two end groups. The molecular weight of the polymer can become very high upon addition of the branching agent, and to avoid excess viscosity during polymerization, an increased amount of a chain stopper agent can be used, relative to the amount used when the particular branching agent is not present. The amount of chain stopper used is generally above 5 mole percent and less than 20 mole percent compared to the bisphenol monomer.

Such branching agents include aromatic triacyl halides, for example triacyl chlorides of formula (12)

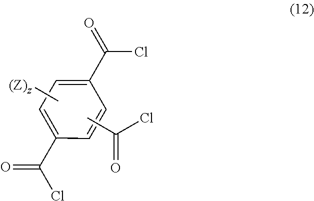

wherein Z is a halogen, C₁₋₃ alkyl, C₁₋₃ alkoxy, C₇₋₁₂ arylalkylene, C₇₋₁₂ alkylarylene, or nitro, and z is 0 to 3; a tri-substituted phenol of formula (13)

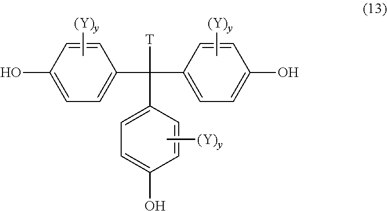

wherein T is a C₁₋₂₀ alkyl, C₁₋₂₀ alkoxy, C₇₋₁₂ arylalkyl, or C₇₋₁₂ alkylaryl, Y is a halogen, C₁₋₃ alkyl, C₁₋₃ alkoxy, C₇₋₁₂ arylalkyl, C₇₋₁₂ alkylaryl, or nitro, s is 0 to 4; or a compound of formula (14) (isatin-bis-phenol).

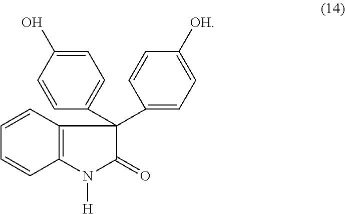 [SMILES: O=C1Nc2ccccc2C1(c1ccc(O)cc1)c1ccc(O)cc1]

Examples of specific branching agents that are particularly effective in the compositions include trimellitic trichloride (TMTC), tris-p-hydroxyphenylethane (THPE), and isatin-bis-phenol.

The amount of the branching agents used in the manufacture of the polymer will depend on a number of considerations, for example the type of R¹ groups, the amount of chain stopper, e.g., cyanophenol, and the desired molecular weight of the polycarbonate. In general, the amount of branching agent is effective to provide 0.1 to 10 branching units per 100 R¹ units, preferably 0.5 to 8 branching units per 100 R¹ units, and more preferably 0.75 to 5 branching units per 100 R¹ units. For branching agents having formula (20), the branching agent is present in an amount to provide 0.1 to 10 triester branching units per 100 R¹ units, preferably 0.5 to 8, and more preferably 0.75 to 5 triester branching units per 100 R¹ units. For branching agents having formula (14), the branching agent is present in an amount effective to provide 0.1 to 10 triphenyl carbonate branching units per 100 R¹ units, preferably 0.5 to 8, and more preferably 2.5 to 3.5 triphenylcarbonate units per 100 R¹ units.

In an aspect, the highly branched polycarbonate comprising units as described above and comprising 1.5-5 mole % branching, comprises greater than or equal to 3 mole %, based on the total moles of the polycarbonate, of moieties derived from a branching agent; and functional groups derived from an end-capping agent having a pKa between 8.3 and 11. The branching agent can comprise trimellitic trichloride, 1,1,1-tris(4-hydroxyphenyl)ethane or a combination of trimellitic trichloride and 1,1,1-tris(4-hydroxyphenyl)ethane, and the end-capping agent is phenol or a phenol containing a substituent of cyano group, aliphatic groups, olefinic groups, aromatic groups, halogens, ester groups, ether groups, or a combination thereof. In a specific aspect, the end-capping agent is phenol, p-t-butylphenol, p-methoxyphenol, p-cyanophenol, p-cumylphenol, or a combination thereof.

In an aspect, the branched polycarbonate comprising units as described above and comprising 0.1 to 1.0 mole % branching, comprises less than 0.5 mole percent, based on the total moles of the polycarbonate, of moieties derived from a branching agent; and functional groups derived from an end-capping agent having a pKa between 8.3 and 11. The branching agent can comprise trimellitic trichloride, 1,1,1-tris(4-hydroxyphenyl)ethane or a combination of trimellitic trichloride and 1,1,1-tris(4-hydroxyphenyl)ethane, and the end-capping agent is phenol or a phenol containing a substituent of cyano group, aliphatic groups, olefinic groups, aromatic groups, halogens, ester groups, ether groups, or a combination thereof. In a specific aspect, the end-capping agent is phenol, p-t-butylphenol, p-methoxyphenol, p-cyanophenol, p-cumylphenol, or a combination thereof.

When present, the branched and highly branched polycarbonates can each independently be included in the composition in an amount of 5 to 50 weight percent, based on the total weight of the composition. Within this range, the branched and highly branched polycarbonates can each independently be included in the composition in an amount of at least 10 weight percent, or at least 12 weight percent, or at least 15 weight percent, or at least 20 weight percent, or at least 35 weight percent, each based on the total weight of the composition. Also within this range, the branched and highly branched polycarbonates can each independently be included in the composition in an amount of at most 45 weight percent, or at most 40 weight percent, or at most 35 weight percent, or at most 30 weight percent, each based on the total weight of the composition. In an aspect, the composition can include the branched polycarbonate, which can be included in the composition in an amount of 35 to 50 weight percent, or 35 to 45 weight percent. In an aspect, the composition can include the highly branched polycarbonate, which can be included in the composition in an amount of 35 to 50 weight percent, or 35 to 45 weight percent. In an aspect, the composition can include a combination the branched and highly branched polycarbonates, and the branched polycarbonate can be present in an amount of 5 to 30 weight percent, or 8 to 28 weight percent, or 10 to 25 weight percent, and the highly branched polycarbonate can be present in an amount of 10 to 35 weight percent, or 12 to 32 weight percent, or 15 to 30 weight percent, each based on the total weight of the composition.

In an aspect, the composition can optionally further include a second linear polycarbonate. The second linear polycarbonate is different from the above-described linear polycarbonate, for example in chemical composition, molecular weight, or both. In an aspect, the second linear polycarbonate has a weight average molecular weight that is greater than the linear polycarbonate. For example, the second linear polycarbonate can have a weight average molecular of 34,000 grams per mole or more, as determined by GPC using polycarbonate standards. For example the second linear polycarbonate can have a weight average molecular weight of 34,500 to 40,000 grams per mole. In an aspect, the second linear polycarbonate can be a linear bisphenol A homopolycarbonate and can have a weight average molecular weight of 34,500 to 40,000 grams per mole.

In an aspect, one or more of the linear polycarbonate, the first and second poly(carbonate-siloxane) copolymer, and, when present, the branched polycarbonate, the highly branched polycarbonate, and the second linear polycarbonate can be derived from post-consumer recycled or post-industrial recycled materials or can be produced from at least one monomer derived from bio-based or plastic waste feedstock.

The polycarbonate composition comprises less than 1 weight percent, or less than 0.5 weight percent, or less than 0.1 weight percent of a flame retardant having a phosphorus-nitrogen bond. In an aspect, a flame retardant having a phosphorus-nitrogen bond can be excluded from the polycarbonate composition. Exemplary flame retardants having a phosphorus-nitrogen bond can include a phosphazene, a phosphonitrilic chloride, a phosphorus ester amide, a phosphoric acid amide, a phosphonic acid amide, a phosphinic acid amide, tris(aziridinyl) phosphine oxide, or a combination thereof.

The polycarbonate composition can optionally further comprise an additive composition. An additive composition can comprise one or more additives selected to achieve a desired property, with the proviso that the additive(s) are also selected so as to not significantly adversely affect the chemical resistance, transparency, and mechanical properties of the polycarbonate composition. The additive composition or individual additives can be mixed at a suitable time during the mixing of the components for forming the composition. The additive can be soluble or non-soluble in polycarbonate. For example, the additive composition can include an impact modifier, flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer. UV absorbing additive, plasticizer, lubricant, release agent (such as a mold release agent), antistatic agent, anti-fog agent, antimicrobial agent, colorant (e.g. a dye or pigment), surface effect additive, radiation stabilizer, or a combination thereof. For example, a combination of a heat stabilizer, mold release agent, and ultraviolet light stabilizer can be used. In general, the additives are used in the amounts generally known to be effective. For example, the total amount of the additive composition (other than any impact modifier, filler, or reinforcing agent) can be 0.001 to 10 wt %, or 0.01 to 5 wt %, each based on the total weight of the polymer in the composition.

In an aspect, the composition can include a heat stabilizer additive. Heat stabilizer additives include organophosphites (e.g., triphenyl phosphite, tris-(2,6-dimethylphenyl)phosphite, tris-(mixed mono- and di-nonylphenyl)phosphite or the like), phosphonates (e.g., dimethylbenzene phosphonate or the like), phosphates (e.g., trimethyl phosphate, or the like), or a combination thereof. The heat stabilizer can be tris(2,4-di-t-butylphenyl) phosphate available as IRGAPHOS™ 168. Heat stabilizers are generally used in amounts of 0.01 to 5 wt %, based on the total weight of the composition.

There is considerable overlap among plasticizers, lubricants, and mold release agents, which include, for example, phthalic acid esters (e.g., octyl-4,5-epoxy-hexahydrophthalate), tris-(octoxycarbonylethyl)isocyanurate, di- or polyfunctional aromatic phosphates (e.g., resorcinol tetraphenyl diphosphate (RDP), the bis(diphenyl) phosphate of hydroquinone and the bis(diphenyl) phosphate of bisphenol A); poly-alpha-olefins; epoxidized soybean oil; silicones, including silicone oils (e.g., poly(dimethyl diphenyl siloxanes); fatty acid esters (e.g., C₁₋₃₂ alkyl stearyl esters, such as methyl stearate and stearyl stearate and esters of stearic acid such as pentaerythritol tetrastearate, glycerol tristearate (GTS), and the like), waxes (e.g., beeswax, montan wax, paraffin wax, or the like), or a combination thereof. These are generally used in amounts of 0.01 to 5 wt %, based on the total weight of the composition.

Light stabilizers, in particular ultraviolet light (UV) absorbing additives, also referred to as UV stabilizers, include hydroxybenzophenones (e.g., 2-hydroxy-4-n-octoxy benzophenone), hydroxybenzotriazines, cyanoacrylates, oxanilides, benzoxazinones (e.g., 2,2′-(1,4-phenylene)bis(4H-3,1-benzoxazin-4-one, commercially available under the trade name CYASORB™ UV-3638 from Cytec), aryl salicylates, hydroxybenzotriazoles (e.g., 2-(2-hydroxy-5-methylphenyl)benzotriazole, 2-(2-hydroxy-5-tert-octylphenyl)benzotriazole, and 2-(2H-benzotriazol-2-yl)-4-(1,1,3,3-tetramethylbutyl)-phenol, commercially available under the trade name CYASORB™ 5411 from Cytec) or a combination thereof. The UV stabilizers can be present in an amount of 0.01 to 1 wt %, preferably, 0.1 to 0.5 wt %, and more preferably, 0.15 to 0.4 wt %, based on the total weight of the composition.

The polycarbonate composition can optionally exclude other components nots specifically described herein. For example, the polycarbonate composition can exclude thermoplastic polymers of that the linear polycarbonate, the first and second poly(carbonate-siloxane) copolymers, the branched and highly branched polycarbonates, and the second linear polycarbonate. In an aspect, a copolycarbonate other than the first and second poly(carbonate-siloxane) copolymers can be excluded from the composition. The composition can optionally minimize or exclude flame retardants.

In an aspect, the polycarbonate composition can comprise 79 to 89 weight percent of the linear polycarbonate; 10 to 16 weight percent of the first poly(carbonate-siloxane) copolymer; and 1 to 3 weight percent of the second poly(carbonate-siloxane) copolymer; wherein the polycarbonate composition has a total siloxane content of 1 to 3 weight percent, based on the total weight of the composition.

In an aspect, the polycarbonate composition can comprise 40 to 74 weight percent of the linear polycarbonate; 10 to 16 weight percent of the first poly(carbonate-siloxane) copolymer; 1 to 3 weight percent of the second poly(carbonate-siloxane) copolymer; 5 to 30 weight percent of a branched polycarbonate comprising 0.1-1.0 mole % branching; and 10 to 35 weight percent of a highly branched polycarbonate comprising 1.5-5.0 mole % branching; wherein the polycarbonate composition has a total siloxane content of 1 to 3 weight percent, based on the total weight of the composition.

In an aspect, the polycarbonate composition can comprise 40 to 54 weight percent of the linear polycarbonate; 10 to 16 weight percent of the first poly(carbonate-siloxane) copolymer; 1 to 3 weight percent of the second poly(carbonate-siloxane) copolymer; 35 to 50 weight percent of a branched polycarbonate comprising 0.1 to 1.0 mole percent branching; and wherein the polycarbonate composition has a total siloxane content of 1 to 3 weight percent, based on the total weight of the composition.

In an aspect, the polycarbonate composition can comprise 40 to 54 weight percent of the linear polycarbonate; 10 to 16 weight percent of the first poly(carbonate-siloxane) copolymer; 1 to 3 weight percent of the second poly(carbonate-siloxane) copolymer; 35 to 50 weight percent of a second linear polycarbonate having a molecular weight of 35.000 g/mol or more, as determined by gel permeation chromatography relative to linear bisphenol A polycarbonate standards; wherein the polycarbonate composition has a total siloxane content of 1 to 3 weight percent, based on the total weight of the composition.

The composition can advantageously exhibit one or more desirable properties. For example, it was found that improved chemical resistance can unexpectedly be obtained by the composition of the present disclosure. In an exemplary aspect, the polycarbonate composition can have a tensile strain at yield of at least 50%, or at least 75%, or at least 90% of the tensile strain at yield of a non-exposed reference tested at the same temperature after exposure of an ISO tensile bar for 72 hours to sunscreen or insect repellant at a temperature of 23° C. under 0.5% or 1% strain. In an aspect, the polycarbonate composition can have a tensile elongation at break of at least 50%, or at least 75%, or at least 90% of the tensile elongation at break of a non-exposed reference tested at the same temperature after exposure of an ISO tensile bar for 72 hours to sunscreen or insect repellant at a temperature of 23° C. under 0.5% or 1% strain.

The polycarbonate composition can further have good melt viscosity, which aids in processing. The polycarbonate composition can have a melt volume rate (MVR, cubic centimeters per 10 minutes (cm³/10 min)) of 3 to 20 or 3 to 15, greater or equal to 3, determined in accordance with ASTM D1238-04 under a load of 1.2 kg at 300° C. for 6 minutes.

The polycarbonate composition can have a heat deflection temperature (HDT) of 110° C. or higher as measured on a sample plaque of 4 mm thickness at 1.82 MPa according to ASTM D648.

The polycarbonate composition can be transparent. For example, the polycarbonate composition can exhibit a transmission of at least 60%, or at least 70%, or at least 75% as determined according to ASTM D1003 on a molded sample having a thickness of 2.5 mm.

The polycarbonate composition can be manufactured by various methods known in the art. For example, powdered linear polycarbonate, poly(carbonate-siloxane) and other optional components can be first blended, optionally with any fillers, in a high-speed mixer or by hand mixing. The blend can then be fed into the throat of a twin-screw extruder via a hopper. Alternatively, at least one of the components can be incorporated into the composition by feeding it directly into the extruder at the throat and/or downstream through a side stuffer, or by being compounded into a masterbatch with a desired polymer and fed into the extruder. The extruder is generally operated at a temperature higher than that necessary to cause the composition to flow. The extrudate can be immediately quenched in a water bath and pelletized. The pellets so prepared can be one-fourth inch long or less as desired. Such pellets can be used for subsequent molding, shaping, or forming.

Shaped, formed, casted, or molded articles comprising the polycarbonate composition are also provided. The polycarbonate composition can be molded into useful shaped articles by a variety of methods, such as injection molding, extrusion, rotational molding, blow molding, and thermoforming. The article can be a molded article, a thermoformed article, an extruded film, an extruded sheet, a honeycomb structure, one or more layers of a multi-layer article, a substrate for a coated article, and a substrate for a metallized article. Exemplary articles can include computer and business machine housings such as housings for monitors, handheld electronic device housings such as housings for cell phones, electrical connectors, and components of lighting fixtures, ornaments, home appliances, roofs, greenhouses, sunrooms, swimming pool enclosures, electronic device casings and signs and the like. In addition, the polycarbonate compositions can be used for such applications as automotive panel and trim. Examples of suitable articles are exemplified by but are not limited to aircraft, automotive, truck, military vehicle (including automotive, aircraft, and water-borne vehicles), scooter, and motorcycle exterior and interior components, including panels, quarter panels, rocker panels, trim, fenders, doors, deck-lids, trunk lids, hoods, bonnets, roofs, bumpers, fascia, grilles, mirror housings, pillar appliqués, cladding, body side moldings, wheel covers, hubcaps, door handles, spoilers, window frames, headlamp bezels, headlamps, tail lamps, tail lamp housings, tail lamp bezels, license plate enclosures, roof racks, and running boards; enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings; personal water-craft; jet-skis; pools; spas; hot tubs; steps; step coverings; building and construction applications such as glazing, roofs, windows, floors, decorative window furnishings or treatments; treated glass covers for pictures, paintings, posters, and like display items; wall panels, and doors; counter tops; protected graphics; outdoor and indoor signs; enclosures, housings, panels, and parts for automatic teller machines (ATM); computer; desk-top computer; portable computer; lap-top computer; hand held computer housings; monitor; printer; keyboards; FAX machine; copier; telephone; phone bezels; mobile phone; radio sender; radio receiver; enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; shoe laces; articles made from plastic-wood combinations; golf course markers; utility pit covers; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated painted articles; coated dyed articles; coated fluorescent articles; coated foam articles; medical device housings; battery housings, including for electric vehicles, electric bikes, and home and industrial electronics; components of charging equipment for an electric vehicle, including wall box housings, connectors, and the like; wireless charging device components; electronic device protection covers; kitchen appliance components; and like applications.

The composition of the present disclosure can be particularly useful in articles for consumer electronic applications. For example, the articles can be a component of a consumer electronic device such as a gaming console, a gaming controller, a portable gaming device, a cellular telephone, a television, a personal computer, a tablet computer, a laptop computer, a personal digital assistant, a portable media player, a digital camera, a portable music player, an appliance, a power tool, a robot, a toy, a greeting card, a home entertainment system, a loudspeaker, or a soundbar. In an aspect, the articles can be an electronic housing for an adapter, a cell phone, a smart phone, a GPS device, a laptop computer, a tablet computer, an e-reader, a copier, or a solar apparatus.

The composition of the present disclosure can be particularly useful in articles for healthcare applications, such as for components used in healthcare, such as, for example hand-held devices and computer monitors, and in particular touch-screens for such devices.

The polycarbonate compositions are further illustrated by the following examples, which are non-limiting.

### Examples

Materials used for the following examples are provided in Table 1.

TABLE 1

| Component | Description | Source |
|---|---|---|
| PC-1 | Linear bisphenol A polycarbonate, CAS Reg. No, 25971-63-5, having a molecular | SABIC |
| | weight (Mw) of 30,000-31,000 g/mole, as determined by GPC and calculated for | |
| | polycarbonate, produced by interfacial polymerization and endcapped with p- | |
| | cumylphenol | |
| PC-2 | Linear bisphenol A polycarbonate, CAS Reg. No, 25971-63-5, having a molecular | SABIC |
| | weight (Mw) of 35,000-38,000 grams per mole, as determined by gel permeation | |
| | chromatography relative to linear bisphenol A polycarbonate standards, produced by | |
| | interfacial polymerization and endcapped with p-cumylphenol | |
| B-PC | Branched bisphenol A homopolymer, containing 0.4 mole % 1,1,1-tris(4- | SABIC |
| | hydroxyphenyl)ethane (THPE) branching agent, having a molecular weight (Mw) of | |
| | 35,000-38,000 g/mole, as determined by gel permeation chromatography relative to | |
| | linear bisphenol A polycarbonate standards, produced by interfacial polymerization | |
| | and endcapped with p-cumylphenol | |
| H-PC | Branched bisphenol A polycarbonate containing about 3 mole % of THPE as | SABIC |
| | branching agent with 4-hydroxy benzonitrile as endcap, having a molecular weight | |
| | (Mw) of 26,700-30,700 g/mole, as determined by gel permeation chromatography | |
| | relative to linear bisphenol A polycarbonate standards, produced by interfacial | |
| | polymerization and endcapped with p-cumylphenol | |
| PC-Si-1 | Polycarbonate-siloxane copolymer having a siloxane content of 6 wt %, an average | SABIC |
| | PDMS block length of 45 repeat units, and a weight average molecular weight of | |
| | 20,000 to 24,000 g/mol, as determined by gel permeation chromatography relative to | |
| | linear bisphenol A polycarbonate standards, produced by interfacial polymerization | |
| | and endcapped with p-cumylphenol | |
| PC-Si-2 | Polycarbonate-siloxane copolymer having a siloxane content of 40 wt %, an average | SABIC |
| | PDMS block length of 45 units, and a weight average molecular weight of 37,000 to | |
| | 38,000 g/mol, as determined by gel permeation chromatography relative to linear | |
| | bisphenol A polycarbonate standards, produced by interfacial polymerization and | |
| | endcapped with p-cumylphenol | |
| PC-Si-3 | Polycarbonate-siloxane copolymer having a siloxane content of 20 wt %, an average | SABIC |
| | PDMS block length of 45 units, and a weight average molecular weight of 29,000 to | |
| | 31,000 g/mol, as determined by gel permeation chromatography relative to linear | |
| | bisphenol A polycarbonate standards, produced by interfacial polymerization and | |
| | endcapped with p-cumylphenol | |
| STAB | Phosphite Stabilizer, available as IRGAPHOS ™ 168 | BASF |
| PETS | Pentaerythritol tetrastearate | FACI |
| BZT | Phenol, 2-(2H-benzotriazol-2-yl)-4,6-bis(1-methyl-1-phenylethyl), CAS Reg. No. | BASF |
| | 70321-86-7; available as TINUVIN ™ 234 | |

Typical compounding procedures are described as follows: The various formulations were prepared by direct dry-blending of the raw materials and homogenized with a paint shaker prior to compounding. The formulations were compounded on a 26 mm Coperion ZSK co-rotating twin-screw extruder. A typical extrusion profile is listed in Table 2.

TABLE 2

| Parameters | Unit | 25 mm ZSK |
|---|---|---|
| Feed temperature | ° C. | 177 |
| Zone 1 temperature | ° C. | 232 |
| Zone 2-8 temperature | ° C. | 266 |
| Die temperature | ° C. | 271 |
| Screw speed | rpm | 400 |
| Throughput | kg/h | 70 |
| Torque | % | 75-80 |

A DEMAG molding machine was used to mold the test parts for standard physical property testing. (for parameters see Table 3).

TABLE 3

| Parameters | Unit | |
|---|---|---|
| Pre-drying time | h | 4 |
| Pre-drying temperature | ° C. | 120 |
| Zone 1-3 temperature | ° C. | 290 |
| Nozzle temperature | ° C. | 290 |
| Mold temperature | ° C. | 82 |
| Screw speed | rpm | 100 |
| Back pressure | bar | 3.4 |
| Injection time | s | 1-2 |
| Approx. cycle time | s | 31-35 |

Sample preparation and testing methods are described in Table 4.

TABLE 4

| Property | Standard | Conditions | Specimen |
|---|---|---|---|
| Melt volume rate | ASTM D1238- | 300° C., 1.2 | Pellets |
| (MVR) | 04 | kg, 6 min | |
| Heat deflection | ASTM D648 | 0.45 MPa, | 3.2 mm bars |
| temperature (HDT) | | 1.82 MPa | |
| Ductility | ASTM 256 | 23° C. | 3.2 mm bars |
| Notched Izod | ASTM 256 | 23° C. | 3.2 mm bars |
| Impact Strength | | | |
| Tensile | ASTM D638 | 23° C., | 3.2 mm bars |
| properties | | 50 mm/min | |
| Transmission | ASTM D1003 | 23° C. | 2.5 mm plaques |
| Haze | ASTM D1003 | 23° C. | 2.5 mm plaques |

Chemical resistance was determined according to ASTM D-543. In particular, chemical resistance can be demonstrated by the retention (expressed in %) of tensile strength at yield and tensile elongation at break. Chemical resistance was evaluated on 3.2 mm ASTM tensile bars at 23° C. after exposure to a chemical agent. In particular, the ASTM tensile bars are bent to specific strain levels (e.g., 0.5% or 1% in a test fixture) and the bars are kept in constant exposure to the strain and chemical agent for a specified test period. Bars may be wrapped so that they are kept saturated while in contact with the strained area. After a pre-determined amount of time, the retention (expressed in %) of tensile stress at yield and tensile elongation at break are measured.

Table 5 shows the compositions and properties for the following examples. Amounts of each component are provided in weight percent based on the total weight of the composition.

TABLE 5

| | Unit | CE1 | CE2 | CE3 | CE4 | E1 | E2 | E3 |
|---|---|---|---|---|---|---|---|---|
| Component | | | | | | | | |
| PC-1 | % | 62.3 | 62.3 | 33.3 | 33.3 | 44.92 | 44.92 | 44.92 |
| PC-2 | % | 22 | 12 | 22 | 12 | | | |
| B-PC | % | | 10 | | 10 | 10 | 25 | 40 |
| H-PC | % | | | 29 | 29 | 30 | 15 | |
| PC-Si-1 | | | | | | 13 | 13 | 13 |
| PC-Si-2 | % | 15 | 15 | 15 | 15 | 2 | 2 | 2 |
| PC-Si-3 | % | | | | | | | |
| PETS | % | 0.3 | 0.3 | 0.3 | 0.3 | | | |
| BZT | % | 0.3 | 0.3 | 0.3 | 0.3 | | | |
| STAB | % | 0.1 | 0.1 | 0.1 | 0.1 | 0.08 | 0.08 | 0.08 |
| Properties | | | | | | | | |
| Si content | % | 6.0 | 6.0 | 6.0 | 6.0 | 1.6 | 1.6 | 1.6 |
| Mod. of | MPa | 1950 | 1950 | 2034 | 2048 | 2194 | 2142 | 2136 |
| Elast. | | | | | | | | |
| Tens. | MPa | 52.1 | 52.6 | 54.3 | 55.0 | 60.9 | 60.0 | 59.6 |
| Strength at | | | | | | | | |
| yld | | | | | | | | |
| Tens. | MPa | 56 | 58 | 56 | 55 | 59 | 59 | 56 |
| Strength at | | | | | | | | |
| brk | | | | | | | | |
| % Elong. at | % | 5.7 | 5.7 | 5.6 | 5.6 | 6.2 | 6.3 | 6.5 |
| yld | | | | | | | | |
| % Elong. at | % | 129 | 123 | 111 | 89 | 96 | 96 | 81 |
| brk | | | | | | | | |
| MVR, | cm³/ | 10.3 | 8.7 | 6.4 | 5.3 | 5.6 | 4.4 | 3.3 |
| 300° C., 1.2 | 10 | | | | | | | |
| kg, 360 s | min | | | | | | | |
| HDT, | ° C. | | | | | 128 | 129 | 131 |
| 0.45 MPa | | | | | | | | |
| HDT, | ° C. | | | | | | | |
| 1.8 MPa | | | | | | | | |
| NII, 23° C., | J/m | | | | | 824 | 885 | 929 |
| 5.5 J | | | | | | | | |
| Ductility, | % | | | | | 100 | 100 | 100 |
| 23° C., 5.5 J | | | | | | | | |
| NII, 0° C., | J/m | 717 | 710 | 654 | 666 | | | |
| 5.5 J | | | | | | | | |
| Ductility, | % | 100 | 100 | 100 | 100 | | | |
| 0° C., 5.5 J | | | | | | | | |
| NII, −10° C., | J/m | | | | | 673 | 741 | 764 |
| 2.75 J | | | | | | | | |
| Ductility, −10° | % | | | | | 100 | 100 | 100 |
| C., 2.75 J | | | | | | | | |
| Trans. | % | * | * | * | * | 78.9 | 78.6 | 79.8 |
| Haze | % | * | * | * | * | 8.1 | 8.4 | 7.2 |
| Tens. | | 0% | 0% | 0% | 0% | 100% | 99% | 97% |
| Strength | | | | | | | | |
| Ret. @ yld, | | | | | | | | |
| sunscreen, | | | | | | | | |
| 1.0% strain, | | | | | | | | |
| 3 days, RT | | | | | | | | |
| Tens. | | 0% | 0% | 0% | 0% | 48% | 96% | 103% |
| Elong. @ | | | | | | | | |
| brk, | | | | | | | | |
| sunscreen, | | | | | | | | |
| 1.0% strain, | | | | | | | | |
| 3 days, RT | | | | | | | | |
| Tens. | | 100% | 99% | 99% | 99% | 101% | 100% | 98% |
| Strength | | | | | | | | |
| Ret. @ yld, | | | | | | | | |
| insect | | | | | | | | |
| repellant | | | | | | | | |
| wipes, | | | | | | | | |
| 0.5% strain, | | | | | | | | |
| 3 days, RT | | | | | | | | |
| Tens. | | 107% | 72% | 57% | 79% | 89% | 83% | 101% |
| Elong. @ | | | | | | | | |
| brk, insect | | | | | | | | |
| repellant | | | | | | | | |
| wipes, | | | | | | | | |
| 0.5% strain, | | | | | | | | |
| 3 days, RT | | | | | | | | |

| | E4 | E5 | E6 | CE5 | CE6 | CE7 | CE8 |
|---|---|---|---|---|---|---|---|
| Component | | | | | | | |
| PC-1 | 84.92 | 44.92 | 44.92 | 44.92 | 6 | 3.99 | 44.97 |
| PC-2 | | 40 | | | 10.94 | 27.98 | 37.5 |
| B-PC | | | | 40 | | | |
| H-PC | | | 40 | | | | |
| PC-Si-1 | 13 | 13 | 13 | 15 | 83 | 57.97 | |
| PC-Si-2 | 2 | 2 | 2 | | | | |
| PC-Si-3 | | | | | | | 17.5 |
| PETS | | | | | | | |
| BZT | | | | | | | |
| STAB | 0.08 | 0.08 | 0.08 | 0.08 | 0.06 | 0.06 | 0.03 |
| Properties | | | | | | | |
| Si content | 1.6 | 1.6 | 1.6 | 0.9 | 5.0 | 3.5 | 3.5 |
| Mod. of | 2068 | 2056 | 2102 | 2200 | 2180 | 2210 | 2020 |
| Elast. | | | | | | | |
| Tens. | 58.2 | 58.1 | 59.7 | 61.7 | 57 | 58 | 55 |
| Strength at | | | | | | | |
| yld | | | | | | | |
| Tens. | 70 | 71 | 65 | 60 | 59 | 64 | 50 |
| Strength at | | | | | | | |
| brk | | | | | | | |
| % Elong. at | 6.5 | 6.5 | 6.6 | 6.2 | 5.6 | 5.8 | 6.0 |
| yld | | | | | | | |
| % Elong. at | 140 | 138 | 116 | 106 | 124 | 131 | 98 |
| brk | | | | | | | |
| MVR, | 6.9 | 4.9 | 3.3 | 6.8 | 9 | 9 | 9 |
| 300° C., 1.2 | | | | | | | |
| kg, 360 s | | | | | | | |
| HDT, | 131 | 132 | 131 | 126 | | | |
| 0.45 MPa | | | | | | | |
| HDT, | | | | | 120 | 124 | 124 |
| 1.8 MPa | | | | | | | |
| NII, 23° C., | 957 | 960 | 855 | 778 | 824 | 890 | 865 |
| 5.5 J | | | | | | | |
| Ductility, | 100 | 100 | 100 | 100 | 100 | 100 | 100 |
| 23° C., 5.5 J | | | | | | | |
| NII, 0° C., | | | | | | | |
| 5.5 J | | | | | | | |
| Ductility, | | | | | | | |
| 0° C., 5.5 J | | | | | | | |
| NII, −10° C., | 773 | 827 | 747 | 389 | | | |
| 2.75 J | | | | | | | |
| Ductility, −10° | 100 | 100 | 100 | 0 | | | |
| C., 2.75 J | | | | | | | |
| Trans. | | | | | 82 | 82 | * |
| Haze | | | | | 3 | 3 | * |
| Tens. | 101% | 100% | 100% | 0% | 0% | 0% | |
| Strength | | | | | | | |
| Ret. @ yld, | | | | | | | |
| sunscreen, | | | | | | | |
| 1.0% strain, | | | | | | | |
| 3 days, RT | | | | | | | |
| Tens. | 101% | 100% | 101% | 0% | 0% | 0% | |
| Elong. @ | | | | | | | |
| brk, | | | | | | | |
| sunscreen, | | | | | | | |
| 1.0% strain, | | | | | | | |
| 3 days, RT | | | | | | | |
| Tens. | 99% | 100% | 99% | 100% | 99% | 100% | |
| Strength | | | | | | | |
| Ret. @ yld, | | | | | | | |
| insect | | | | | | | |
| repellant | | | | | | | |
| wipes, | | | | | | | |
| 0.5% strain, | | | | | | | |
| 3 days, RT | | | | | | | |
| Tens. | 95% | 97% | 94% | 87% | 91% | 101% | |
| Elong. @ | | | | | | | |
| brk, insect | | | | | | | |
| repellant | | | | | | | |
| wipes, | | | | | | | |
| 0.5% strain, | | | | | | | |
| 3 days, RT | | | | | | | |

* these materials are visually opaque and transmission/haze was not determined

As shown in Table 5, the comparative example % generally exhibit a balance of processability and good mechanical properties but are not chemically resistant to both the sunscreen and the insect repellant wipes tested. The compositions of CE2-CE4 demonstrate that addition of a branched or a highly branched polycarbonate component negatively affects the chemical resistance.

It was thus unexpected that the compositions according to E1-E3 exhibited improved chemical resistance compared to the CE1-CE4 compositions. Additionally, the compositions of E1-E3 have a lower total siloxane content relative to CE1-CE4 and CE6-CE8, and thus also have improved transparency. It was also noted that the compositions of CE4 and E1 include similar amounts of the PC—Si, the B—PC and the H—PC components, yet the chemical resistance performance of the E1 composition was significantly improved. The compositions of E4-E5 and CE5 further show that reducing the amount of highly branched polycarbonate in favor of branched polycarbonate can provide an enhanced property balance, including excellent chemical resistance. Accordingly, a significant improvement in chemically resistance polycarbonate compositions is provided by the present disclosure.

This disclosure further encompasses the following aspects.

Aspect 1: A polycarbonate composition comprising: 35 to 94 weight percent of a linear polycarbonate; 5 to 20 weight percent of a first poly(carbonate-siloxane) copolymer having a siloxane content of 4 to 15 weight percent, based on the total weight of the first poly(carbonate-siloxane) copolymer; and 1 to 6 weight percent of a second poly(carbonate-siloxane) copolymer having a siloxane content of 35 to 60 weight percent, based on the total weight of the second poly(carbonate-siloxane) copolymer; wherein weight percent of each component is based on the total weight of the composition; wherein the polycarbonate composition has a total siloxane content of less than 2.5 weight percent, based on the total weight of the composition; and wherein the composition comprises less than 1 weight percent of a flame retardant having a phosphorus-nitrogen bond.

Aspect 2: The polycarbonate composition of aspect 1, further comprising a highly branched polycarbonate comprising 1.5 to 5.0 mole percent branching.

Aspect 3: The polycarbonate composition of aspect 1 or 2, further comprising a branched polycarbonate comprising 0.1 to 1.0 mole percent branching.

Aspect 4: The polycarbonate composition of any of aspects 1 to 3, further comprising a second linear polycarbonate having a molecular weight of 34.000 g/mol or more, as determined by gel permeation chromatography relative to linear bisphenol A polycarbonate standards.

Aspect 5: The polycarbonate composition of any of aspects 1 to 4, wherein the flame retardant having a phosphorus-nitrogen bond is excluded from the composition, preferably wherein the flame retardant having a phosphorus-nitrogen bond comprises a phosphazene, a phosphonitrilic chloride, a phosphorus ester amide, a phosphoric acid amide, a phosphonic acid amide, a phosphinic acid amide, tris(aziridinyl) phosphine oxide, or a combination thereof.

Aspect 6: The polycarbonate composition of aspect 1, comprising: 79 to 89 weight percent of the linear polycarbonate; 10 to 16 weight percent of the first poly(carbonate-siloxane) copolymer; and 1 to 3 weight percent of the second poly(carbonate-siloxane) copolymer; wherein the polycarbonate composition has a total siloxane content of 1 to 3 weight percent, based on the total weight of the composition.

Aspect 7: The polycarbonate composition of aspect 1, comprising: 40 to 74 weight percent of the linear polycarbonate; 10 to 16 weight percent of the first poly(carbonate-siloxane) copolymer; 1 to 3 weight percent of the second poly(carbonate-siloxane) copolymer; 5 to 30 weight percent of a branched polycarbonate comprising 0.1 to 1.0 mole percent branching; and 10 to 35 weight percent of a highly branched polycarbonate comprising 1.5 to 5.0 mole percent branching; wherein the polycarbonate composition has a total siloxane content of 1 to 3 weight percent, based on the total weight of the composition.

Aspect 8: The polycarbonate composition of aspect 1, comprising: 40 to 54 weight percent of the linear polycarbonate; 10 to 16 weight percent of the first poly(carbonate-siloxane) copolymer; 1 to 3 weight percent of the second poly(carbonate-siloxane) copolymer; 35 to 50 weight percent of a branched polycarbonate comprising 0.1 to 1.0 mole percent branching; and wherein the polycarbonate composition has a total siloxane content of 1 to 3 weight percent, based on the total weight of the composition.

Aspect 9: The polycarbonate composition of aspect 1, comprising: 40 to 54 weight percent of the linear polycarbonate; 10 to 16 weight percent of the first poly(carbonate-siloxane) copolymer; 1 to 3 weight percent of the second poly(carbonate-siloxane) copolymer; 35 to 50 weight percent of a second linear polycarbonate having a molecular weight of 35,000 g/mol or more, as determined by gel permeation chromatography relative to linear bisphenol A polycarbonate standards; wherein the polycarbonate composition has a total siloxane content of 1 to 3 weight percent, based on the total weight of the composition.

Aspect 10: The polycarbonate composition of any of aspects 1 to 9, further comprising an additive composition.

Aspect 11: The polycarbonate composition of any of aspects 1 to 10, wherein a molded sample of the composition has: a transmission of at least 60%, or at least 70%, or at least 75% as determined according to ASTM D1003 on a molded sample having a thickness of 2.5 mm; and a tensile strain at yield of at least 50%, or at least 75%, or at least 90% of the tensile strain at yield of a non-exposed reference tested at the same temperature after exposure of an ISO tensile bar for 72 hours to sunscreen or insect repellant at a temperature of 23° C. under 0.5% or 1% strain.

Aspect 12: A method of making the polycarbonate composition of any one of the preceding aspects, the method comprising melt-mixing the components of the composition.

Aspect 13: The method of aspect 12, further comprising molding, casting, or extruding the composition to provide an article.

Aspect 14: An article comprising the polycarbonate composition according to any of aspects 1 to 11.

Aspect 15: The article of aspect 14, wherein the article is a consumer electronic component or a component of a medical device.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A polycarbonate composition comprising:
35 to 94 weight percent of a linear polycarbonate;
5 to 20 weight percent of a first poly(carbonate-siloxane) copolymer having a siloxane content of 4 to 15 weight percent, based on the total weight of the first poly(carbonate-siloxane) copolymer; and
1 to 6 weight percent of a second poly(carbonate-siloxane) copolymer having a siloxane content of 35 to 60 weight percent, based on the total weight of the second poly(carbonate-siloxane) copolymer;
wherein weight percent of each component is based on the total weight of the composition;
wherein the polycarbonate composition has a total siloxane content of less than 2.2 weight percent, based on the total weight of the composition;
wherein the composition comprises less than 1 weight percent of a flame retardant having a phosphorus-nitrogen bond; and
wherein a molded sample of the composition has a transmission of at least 60%, or at least 70%, or at least 75% as determined according to ASTM D1003 on a molded sample having a thickness of 2.5 mm.

2. The polycarbonate composition of claim 1, further comprising a highly branched polycarbonate comprising 1.5 to 5.0 mole percent branching.

3. The polycarbonate composition of claim 1, further comprising a branched polycarbonate comprising 0.1 to 1.0 mole percent branching.

4. The polycarbonate composition of claim 1, further comprising a second linear polycarbonate having a weight average molecular weight of 34,000 g/mol or more, as determined by gel permeation chromatography relative to linear bisphenol A polycarbonate standards.

5. The polycarbonate composition of claim 1, wherein the flame retardant having a phosphorus-nitrogen bond is excluded from the composition.

6. The polycarbonate composition of claim 1, comprising:
79 to 89 weight percent of the linear polycarbonate;
10 to 16 weight percent of the first poly(carbonate-siloxane) copolymer; and
1 to 3 weight percent of the second poly(carbonate-siloxane) copolymer;
wherein the polycarbonate composition has a total siloxane content of 1 to less than 2.2 weight percent, based on the total weight of the composition.

7. The polycarbonate composition of claim 1, comprising:
40 to 74 weight percent of the linear polycarbonate;
10 to 16 weight percent of the first poly(carbonate-siloxane) copolymer;
1 to 3 weight percent of the second poly(carbonate-siloxane) copolymer;
5 to 30 weight percent of a branched polycarbonate comprising 0.1 to 1.0 mole percent branching; and
10 to 35 weight percent of a highly branched polycarbonate comprising 1.5 to 5.0 mole percent branching;
wherein the polycarbonate composition has a total siloxane content of 1 to less than 2.2 weight percent, based on the total weight of the composition.

8. The polycarbonate composition of claim 1, comprising:
40 to 54 weight percent of the linear polycarbonate;
10 to 16 weight percent of the first poly(carbonate-siloxane) copolymer;
1 to 3 weight percent of the second poly(carbonate-siloxane) copolymer;
35 to 50 weight percent of a branched polycarbonate comprising 0.1 to 1.0 mole percent branching; and
wherein the polycarbonate composition has a total siloxane content of 1 to less than 2.2 weight percent, based on the total weight of the composition.

9. The polycarbonate composition of claim 1, comprising:
40 to 54 weight percent of the linear polycarbonate;
10 to 16 weight percent of the first poly(carbonate-siloxane) copolymer;
1 to 3 weight percent of the second poly(carbonate-siloxane) copolymer;
35 to 50 weight percent of a second linear polycarbonate having a weight average molecular weight of 35,000 g/mol or more, as determined by gel permeation chromatography relative to linear bisphenol A polycarbonate standards;
wherein the polycarbonate composition has a total siloxane content of 1 to less than 2.2 weight percent, based on the total weight of the composition.

10. The polycarbonate composition of claim 1, further comprising an additive composition.

11. The polycarbonate composition of claim 1, wherein a molded sample of the composition has:
a tensile strain at yield of at least 50%, or at least 75%, or at least 90% of the tensile strain at yield of a non-exposed reference tested at the same temperature after exposure of an ISO tensile bar for 72 hours to sunscreen or insect repellant at a temperature of 23° C. under 0.5% or 1% strain.

12. A method of making the polycarbonate composition of claim 1, the method comprising melt-mixing the components of the composition.

13. The method of claim 12, further comprising molding, casting, or extruding the composition to provide an article.

14. An article comprising the polycarbonate composition according to claim 1.

15. The article of claim 14, wherein the article is a consumer electronic component or a component of a medical device.

16. The polycarbonate composition of claim 1, wherein the flame retardant having a phosphorus-nitrogen bond is excluded from the composition, wherein the flame retardant having a phosphorus-nitrogen bond comprises a phosphazene, a phosphonitrilic chloride, a phosphorus ester amide, a phosphoric acid amide, a phosphonic acid amide, a phosphinic acid amide, tris(aziridinyl) phosphine oxide, or a combination thereof
